(19) United States
(12) Patent Application Publication
(10) Pub. No.: US 2016/0048921 A1
(43) Pub. Date: Feb. 18, 2016

(54) INTEREST RATE SWAP AND SWAPTION LIQUIDATION SYSTEM AND METHOD

(71) Applicant: CHICAGO MERCANTILE EXCHANGE INC., Chicago, IL (US)

(72) Inventors: Udesh Jha, Chicago, IL (US); Jingbin Yin, Naperville, IL (US); Andrei Lopatin, Lisle, IL (US); Jalpan Shah, Chicago, IL (US); Chad Voegele, Chicago, IL (US)

(21) Appl. No.: 14/457,680

(22) Filed: Aug. 12, 2014

(51) Int. Cl. G06Q 40/06

(52) U.S. Cl. CPC G06Q 40/06

(57) ABSTRACT

Systems and methods are provided for determining liquidations costs for portfolios of financial instruments. Survey data for liquidation costs at different risk profiles is received from market participants. An initial attempt is made to hedge part of the portfolio. Some hedges may not be available during market stress conditions. A warehousing cost for warehousing the unhedged portion of the portfolio is determined and a re-hedge cost for hedging the partially hedged portfolio when hedges are available is determined. A liquidation cost is a combination of the hedge cost, the warehousing cost and the re-hedge cost. Weighting for Greek ladder may be created by mapping liquidation costs to Greek ladders. Lookup tables may be created from liquidity cost. The lookup tables may be used to look up for liquidity cost using aggregated Greek generated by weighted sum of Greek ladder and provide a simplified mechanism for determining liquidation costs.

### FIELD OF THE INVENTION

Aspects of the invention relate to determining risks and liquidation costs. More particularly, aspects of the invention relate to determining liquidations costs associated with portfolios of financial instruments.

### BACKGROUND

Interest rate swaps are agreements between two parties to exchange one stream of future interest payments for another based on a specified principal amount. One stream typical includes fixed payments and another stream typically includes floating payments that are often linked to an interest rate, such as LIBOR. A swaption is an option to enter into an interest rate swap. A buyer pays an option premium to obtain the right but not the obligation to enter into a specified swap agreement with the issuer on a specified future date.

Exchanges are typically associated with clearing houses that are responsible for settling trading accounts, clearing trades, collecting and maintaining performance bond funds, regulating delivery and reporting trading data. Trades may include trades for interest rate swaps and swaptions. Clearing is the procedure through which the clearing house becomes buyer to each seller of a contract, and seller to each buyer, and assumes responsibility for protecting buyers and sellers from financial loss by assuring performance on each contract. This is effected through the clearing process, whereby transactions are matched.

Clearing houses establish clearing level performance bonds (margins) for traded financial products and establishes minimum performance bond requirements for customers. A performance bond, also referred to as a margin, is the funds that may be required to be deposited by a customer with his or her broker, by a broker with a clearing member or by a clearing member with the clearing house, for the purpose of insuring the broker or clearing house against loss on open contracts. The performance bond is not a part payment on a purchase and helps to ensure the financial integrity of brokers, clearing members and exchanges or other trading entities as a whole. A performance bond to clearing house refers to the minimum dollar deposit which is required by the clearing house from clearing members in accordance with their positions. Maintenance, or maintenance margin, refers to a sum, usually smaller than the initial performance bond, which must remain on deposit in the customer's account for any position at all times. In order to minimize risk to an exchange or other trading entity while minimizing the burden on members, it is desirable to approximate the requisite performance bond or margin requirement as closely as possible to the actual risk of the account at any given time.

Some existing liquidation models use margin requirements as proxies to determine required add-on amounts to account for liquidation costs. However, margin requirements can be pro-cyclical and often do not reflect the cost of hedging large hedged books. Margin requirements are also not good proxies for determining the cost of liquidating a large option portfolio in a market crises condition.

Accordingly, there is a need in the art for systems and methods for determining liquidation costs associated with portfolios of financial instruments.

### SUMMARY OF THE INVENTION

Aspects of the invention overcomes at least some of the problems and limitations of the prior art by providing robust systems and methods for determining liquidation costs. Survey data for liquidation costs at different risk profiles are received. The survey data may include stressed market liquidation costs for risk profiles that are available during stressed market conditions and normal market liquidation costs for risk profiles that are not available during a stressed market condition. Cost functions are created from the survey data for the different risk profiles. Next, a hedge cost for hedging a portion of the portfolio at a first time to create a partially hedged portfolio is determined. A warehousing cost for warehousing an unhedged portion of the portfolio of financial instruments until a second time after the first time is also determined. A re-hedge cost is then determined for hedging the partially hedged portfolio at the second time. The liquidation cost is finally determined by combining the hedge cost, the warehousing cost and the re-hedge cost. Weighting for Greek ladder may be created by mapping liquidation costs to Greek ladders. Lookup tables may be created from liquidity cost. The lookup tables may be used to look up for liquidity cost using aggregated Greek generated by weighted sum of Greek ladder and provide a simplified mechanism for determining liquidation costs.

In other embodiments, the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention.

FIG. 2 illustrates a method of determining liquidation costs of a portfolio of financial instruments in accordance with an embodiment of the invention.

FIG. 3 illustrates an exemplary cost function for a 30 year swap financial instrument.

FIG. 4 illustrates exemplary costs to liquidate a portfolio consisting of a 10yr swap with 5M DV01 and a 30yr swap with 10M DV01.

FIG. 5 shows an example where a spread portfolio was hedged with combination of outrights and spreads

FIG. 6 shows an exemplary process that may use margin amounts to determine warehousing costs in accordance with an embodiment of the invention.

FIG. 7 shows and example of where volatility of volatility stabilized in approximately 10 business days.

FIG. 8 shows exemplary list of different types of Greek.

FIG. 9 illustrates a flow of data that can be used to calculate liquidity cost using simplified model.

FIG. 10 shows a one-sided Greek delta ladder example.

FIG. 11 shows a gross Greek delta ladder example.

FIG. 12 shows an exemplary aggregated risk computation for different Greeks.

FIG. 13 shows exemplary weights for Greeks.

FIG. 14 shows an exemplary delta lookup table in accordance with an embodiment of the invention.

FIG. 15 shows an exemplary gamma lookup table in accordance with an embodiment of the invention.

FIG. 16 shows an exemplary vega lookup table in accordance with an embodiment of the invention.

FIG. 17 shows an exemplary skew lookup table in accordance with an embodiment of the invention.

### DETAILED DESCRIPTION

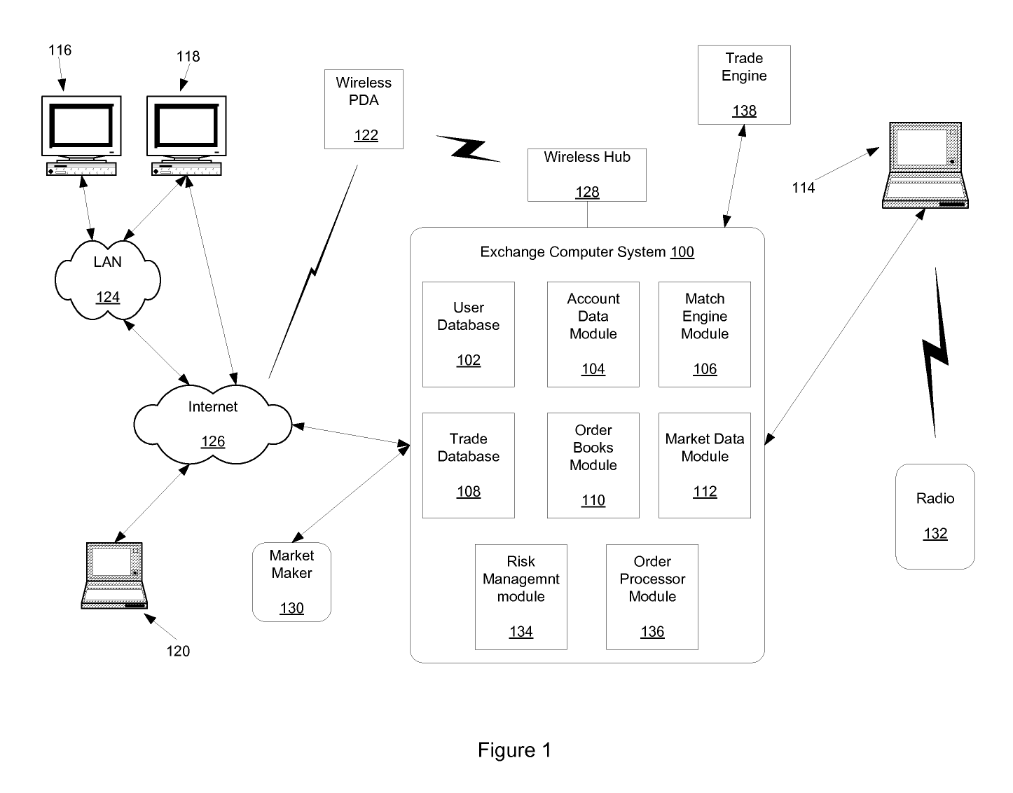

Aspects of the present invention are preferably implemented with computer devices and computer networks that allow users to exchange trading information. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

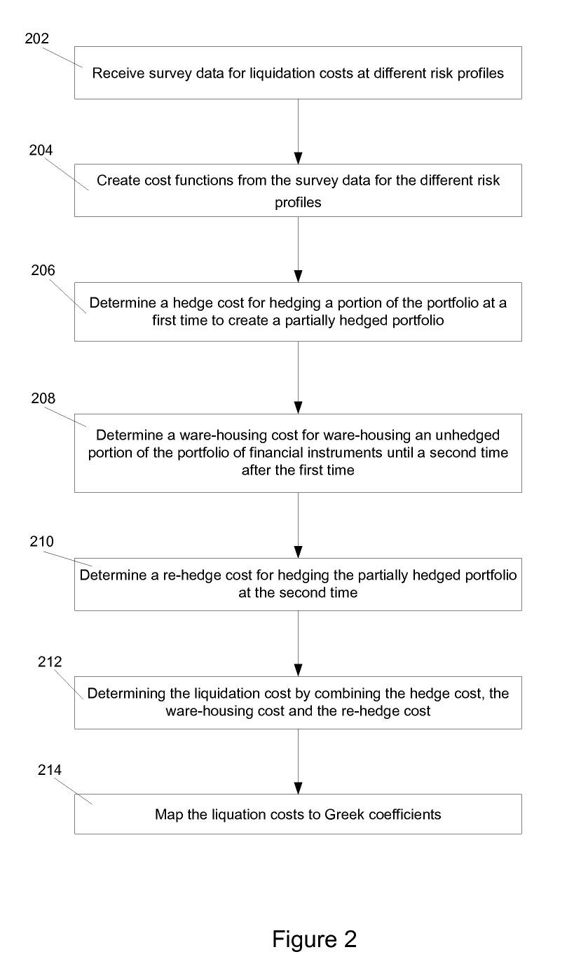

FIG. 2 illustrates a method of determining liquidation costs of a portfolio of financial instruments in accordance with an embodiment of the invention. First, in step 202 survey data for liquidation costs at different risk profiles are received.

The risk profiles may be for various sizes (notional amount or risk amount may be used to measure the size of each risk profile). The survey data may include stressed market liquidation costs for risk profiles that are available during stressed market conditions and normal market liquidation costs for risk profiles that are not available during a stressed market condition. The survey data may be received from FCMs and may represent traders' perceptions of risks. The survey data may include liquidation cost for several representative currencies with significant open interest for liquid tenor points for different risk profiles and for different levels of Risk. Exemplary delta hedging financial instruments include outrights, spreads, butterflies for over the counter transactions and listed futures contacts, such as Eurdollars and treasury contracts. Exemplary delta hedging financial instruments may also include basis swaps (e.g. 1 m vs 3 m, 3 m vs 6 m), OIS swaps and swap spreads (invoice swaps). Exemplary gamma hedging financial instruments include listed options and short-dated straddles. Exemplary vega/skew financial instruments include longer dated straddles, longer dated delta-hedged payers/receivers and risk reversals/butterflies.

The survey data received in step 202 may include discrete data points. In step 204, cost functions may be created from the survey data for the different risk profiles. An exemplary continuous parsimonious cost function that may be used with embodiments of the invention is:

Cost function=a*(Risk̂) Equation 1

Wherein parameters “a” and “b” may be determined by fitting to the mean bid-ask spreads across the survey data quotes per reference instrument.

In an alternative embodiment, Notional values may be used in place of Risk in equation 1.

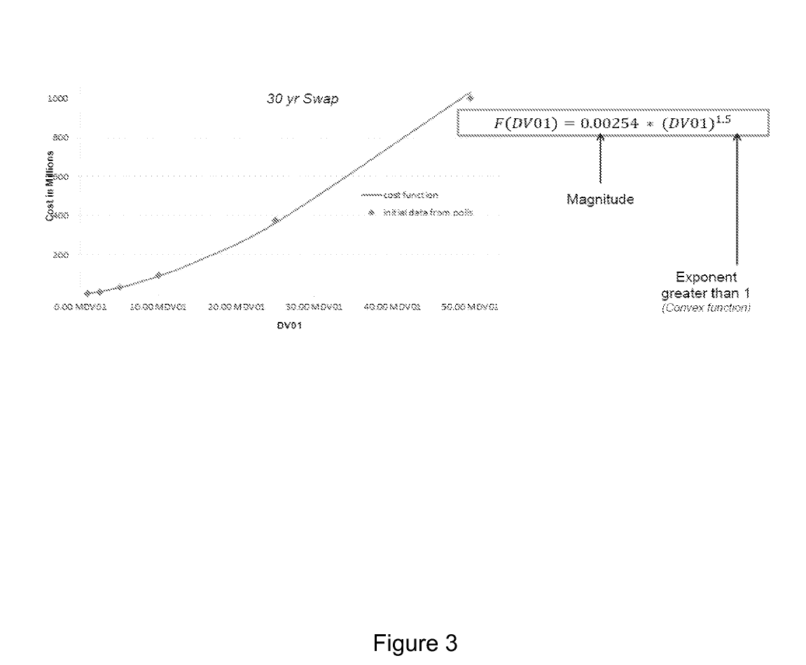

FIG. 3 illustrates an exemplary cost function for a 30 year swap financial instrument. In the example shown, parameter “a” is equal to 0.00254 and parameter “b” is equal to 1.5. Alternative embodiments of the invention may utilize the received survey data to create other continuous or discrete cost functions.

After costs functions are created, in step 206 a hedge cost may be determined. The hedge cost is for hedging a portion of the portfolio at a first time to create a partially hedged portfolio. Step 206 may include identifying optimal hedges using risk profiles that are available during a market crises by minimizing tail risks. The hedges may include delta and gamma hedges. The minimization process may utilize a conditional value at risk (CVaR) measure. In one embodiment of the invention, the function used to minimize tail risks is:

minimi(CVaR+λ*Hedging Cost Function for Reference Instruments) Equation 2

### Wherein “λ” is the Regularization Parameter.

The parameter “λ” may be used to minimize over fitting. Weighting the hedging cost for the reference instruments, as shown in Equation 2, minimizes over-fitting due to overlapping hedging instruments.

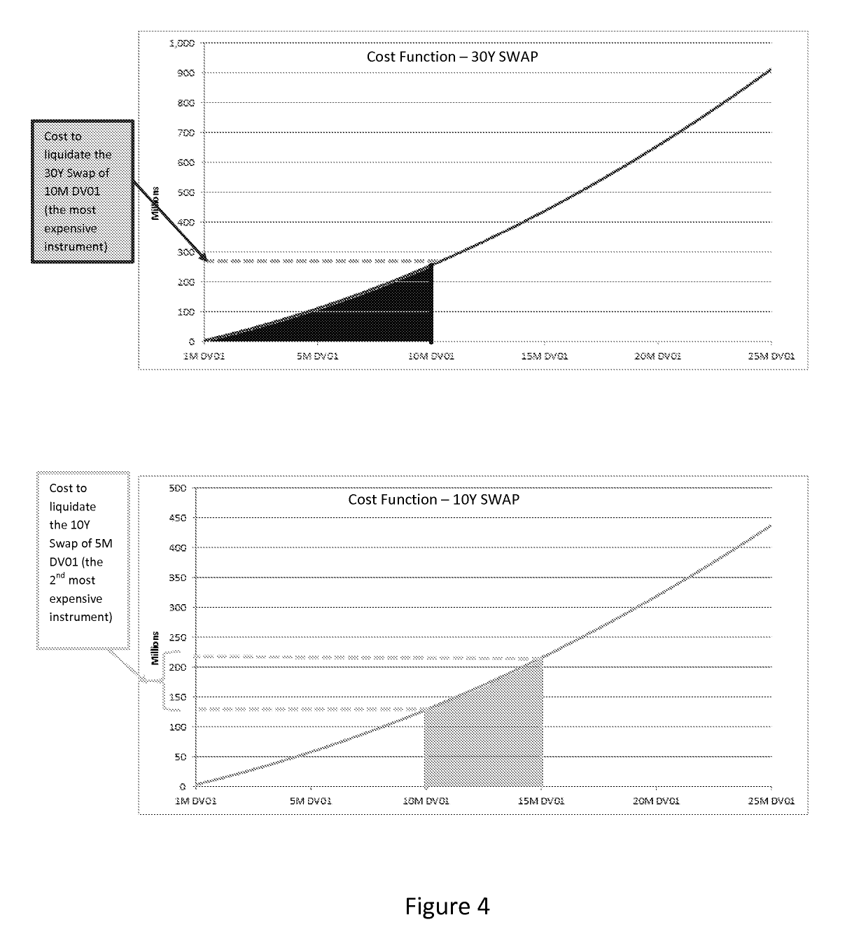

Embodiments of the invention may impose constraints when minimizing tailing risks to ensure that the process will mirror the hedging process likely to be adopted in a default (also practiced in the drills). Hedging cost may include the cost of overall risk transfer into the cost of incremental hedging and may include the impact of overall risk transfer on the cost function of subsequent hedges. For example, as shown in FIG. 4, to calculate the cost to liquidate a portfolio consisting of a 10yr swap with 5M DV01 and a 30yr swap with 10M DV01, the amount of DV01 of the most expensive instrument is mapped to the appropriate cost on its cost function, i.e. 10M of 30Y Swap is charged from 0M to 10M on its cost function; when calculating the cost of liquidating the next most expensive instrument, that instrument's cost function is used, and the cost is calculated using the DV01 associated with that instrument, starting at the DV01 of the most expensive instrument, i.e. 5M of 10Y Swap is charged from 10M to 15M on its cost function; this will continue for each instrument in the hedges of similar type of risks. In some embodiments the order of liquidation of financial instruments is in accordance with a predetermined order. For example, the financial instruments that are most costly (steeper) may be liquidated first.

The process of selecting hedges may account for different risk types (outrights, spreads, butterfly, basis, OIS, gamma, vega, etc.) and the process should not add additional risk to the defaulted portfolio. The process may also require that hedges do not add risk in the same direction as that of the defaulted portfolio.

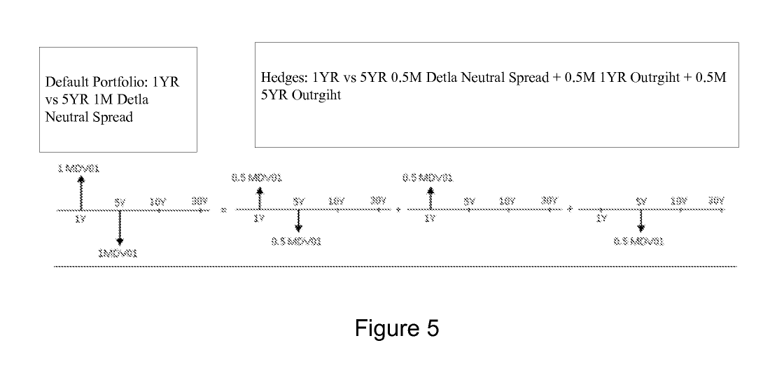

The cost of hedging may be determined based on the quantities of reference instrument identified and using the equivalent cost functions that take into account of the impact of overall risk transfer. The received survey data may include higher order risk profiles, such as spreads and butterflies, in addition to the outrights. Two embodiments of the invention account for lower liquidity cost instruments. In a first embodiment, all of the instruments included in the survey data, such as outrights, spreads and butterflies are included in an optimizer process that minimizes tail risks. This embodiment may result in some incoherent hedges where outrights only portfolios are hedged with combinations of butterfly and spreads or vice-versa. FIG. 5 shows an example where a spread portfolios was hedged with combination of outrights and spreads.

In the second embodiment, the optimization process may be configured to solve for the quantities for the pillars tenors and then decompose the pillars tenor quantities into outrights, spreads and butterflies as below:
Outrights: Spreads and Butterflies are delta neutral. Hence if the sum of the pillars quantities is not zero implies the need to add outrights. The quantities for the possible combinations of outrights are identified by minimizing the hedging cost of these outrights under the constraint that the sum of outrights quantities is the same as the sum of the pillars quantities and no additional risk is added to each pillars.
Butterflies: After taking out the outrights, the remaining pillar quantities have sum of zero. The quantities for the possible combinations of butterflies are identified by maximizing the total quantities of these butterflies under the constraint that no additional risk is added. Since the sum of DV01 is zero for butterfly, the remaining portfolio is still DV01 neutral after this step.
Spread: Finally perform the same optimization for spread to void the remaining DV01.

Returning to FIG. 2, in step 208 a warehousing cost for warehousing an unhedged portion of the portfolio of financial instruments until a second time after the first time is determined. Some financial instruments may not be available during a market stress condition but will be available at a later time, such as 10 days later.

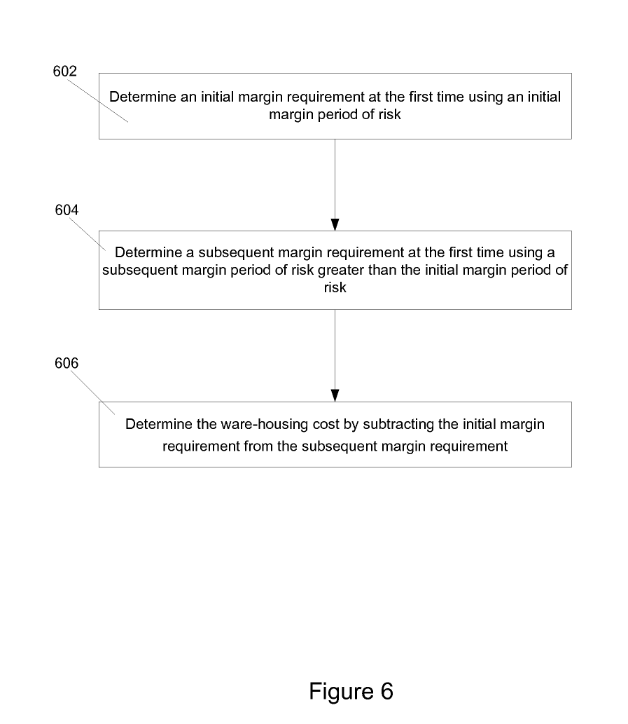

FIG. 6 shows an exemplary process that may use margin amounts to determine warehousing costs in accordance with an embodiment of the invention. First, step 602 an initial margin requirement is determined using an initial margin period of risk (MPOR). The initial margin period of risk may be 5 business days. Next, in step 604 a subsequent margin requirement is determined using a subsequent margin period of risk that is greater than the initial margin period of risk. The subsequent margin period of risk may be 10 business days. Steps 602 and 604 may be performed at the same time, such as during the same day. Finally, in step 606 the warehousing cost may be determined by subtracting the initial margin requirement from the subsequent margin requirement.

Warehousing costs may also be represented by the following equation:

Cost of WareHousing=Margin_{day}−Margin_{day} Equation 3

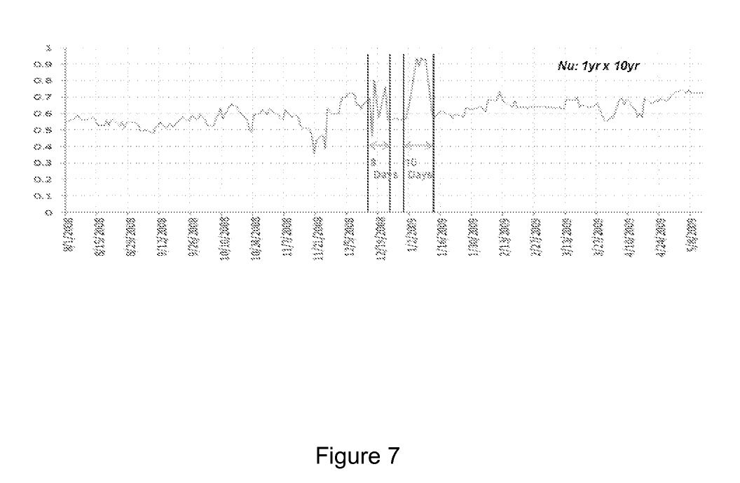

The volatility of volatility (e.g. Nu parameter of SABR model) may be used as an indicator in identifying the sufficient level of margin period of risk MPOR. Stabilization of volatility of volatility just after major crises can be a proxy for determining when a supply hedges will return to the market. FIG. 7 shows an example of where volatility of volatility stabilized in approximately 10 business days.

In step 210, a re-hedge cost is determined for hedging the partially hedged portfolio at a later time. Step 210 may be performed around the same time as step 206 may assume that the re-hedging will occur after stabilization of the market. Re-hedging may use some or all of the hedging and optimization processes described above.

In step 212 the liquidation cost may be determined by combining the hedge cost, the warehousing cost and the re-hedge cost. In some embodiments the hedge cost, the warehousing cost and the re-hedge cost may be summed. Other embodiments may include weighted sums or other combinations.

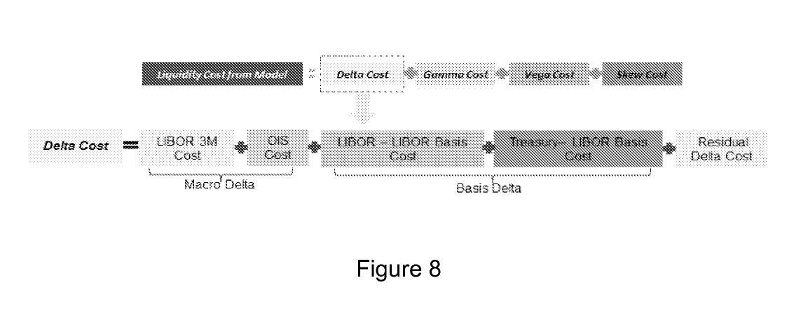

In step 214, the liquation costs determined in step 212 may be mapped to Greek coefficients to create tables that are transparent and easy to use. Weights for Greek coefficients may be determined by regressing liquidation costs determined in step 212 to the Greek coefficients. FIG. 8 shows that Greeks may represent Delta cost, Gamma cost, Vega cost and Skew cost. Figure also shows exemplary delta types. An aggregated Greek may be determined by aggregating a weighted sum of the Greek coefficients and the weights. The aggregated Greeks may be placed in a lookup table. Minimizing risk (CVaR or Margins) can be considered analogous to reducing the Greek Ladders for a defaulted portfolio.

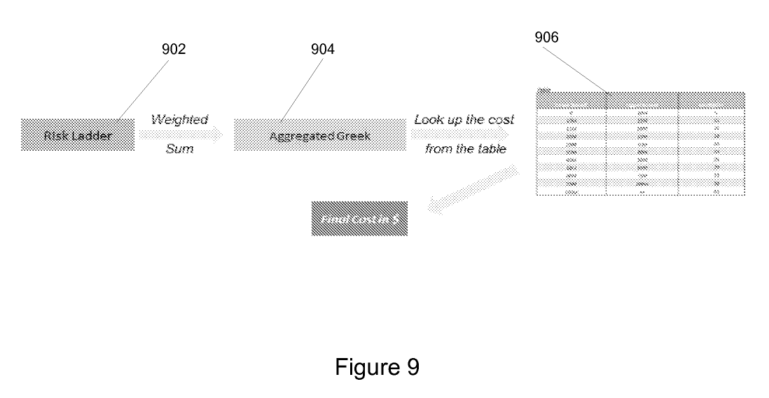

FIG. 9 illustrates a flow of data that can be used to calculate the liquidity cost for one Greek type. As is shown in FIG. 9, risk ladder 902 is collapsed using weighted sum to a single aggregated risk number 904. Liquidation table 906 may be built using a piecewise linear fit of the liquidity cost function of key instrument. The lower and upper bounds are used to apply unique multipliers to each amount of aggregated risk number. The multipliers increase to account for the increased liquidity cost per unit of risk as the size of the position increases.

The weights used in generating aggregated risk number 904 from risk ladder 902 are produced by regressing the risk ladder against the liquidation cost. The weights may be different for positive and negative Greeks due to asymmetric liquidity costs for long and short positions; the weights may be different for different risk profiles of the same Greek type due to the liquidity cost differential (e.g. 1M DV01 of 10yr in general is cheaper to liquidate than 1M DV01 of 30yrs, hence, the weight for 30Y DV01 should be larger than 10Y DV01), which may be considered a key essence of the liquidity cost; in addition, to ensure the aggregated risk number 804 captures not only the liquidity risk for directional portfolios but also captures the liquidity risk for hedged yet very large portfolios, a measurement of gross risk is introduced to the Greek ladder 902.

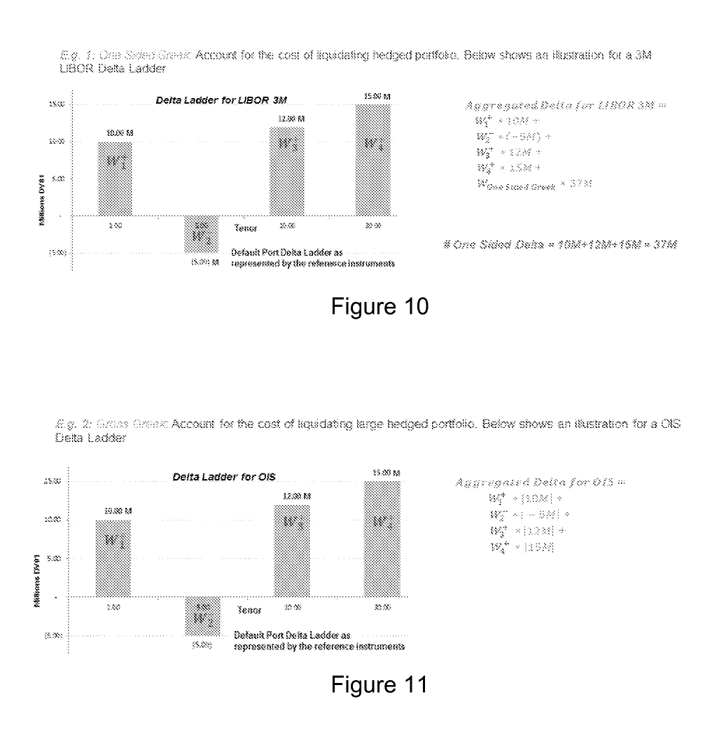

The cost of liquidating large hedged books may be better regressed on a gross measure of Greek than a net measure (one sided Greek, gross Greek, etc.). One sided Greek and gross Greek examples are shown in FIGS. 10 and 11, respectively.

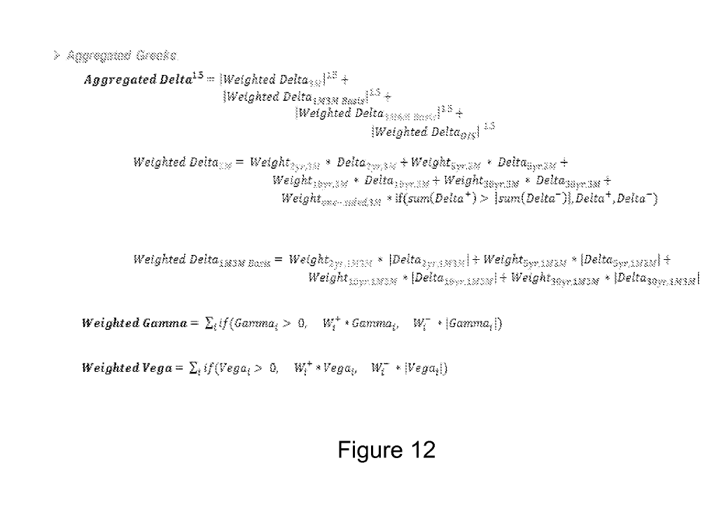

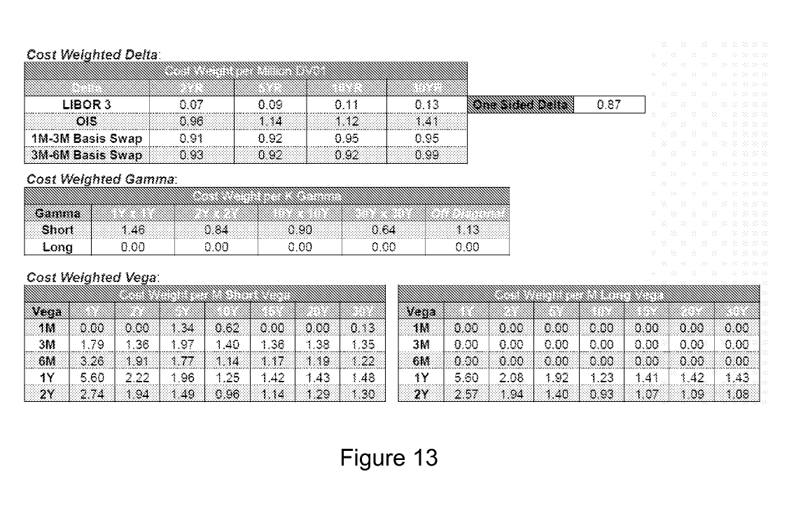

FIG. 12 shows an exemplary aggregated risk computation for different Greeks. Exemplary weights for Greeks are shown in FIG. 13.

Some embodiments of the invention may utilize minimum thresholds. For small or mid-size portfolios, initial margin requirements may contain enough liquidation premium and liquidation add on costs are not necessary. Liquidation add-on may only be applied to large portfolios that bring in significant liquidation risk. A minimum threshold may be used to differentiate large portfolios vs. small or mid-size portfolios for each of the Greeks. Base initial margin requirements are built on 5-days of un-hedged exposure and portfolios of small to med-size can be hedged and liquidated well within that timeframe. For Delta/Gamma, some portion of the risk may be hedged with access to listed market. For swaptions portfolios decaying the portfolio for 5-days in initial margin calculation captures significant amount of time-decay in the process, more than that required for small portfolios. Portfolios of small to med-size are unlikely to significantly move the market against us upon liquidation; also a DM process includes best practices towards minimizing the cost of liquidation (e.g. splitting the book). From a risk management standpoint, a minimum threshold provides the incentive to spread a large book across different clearing firms.

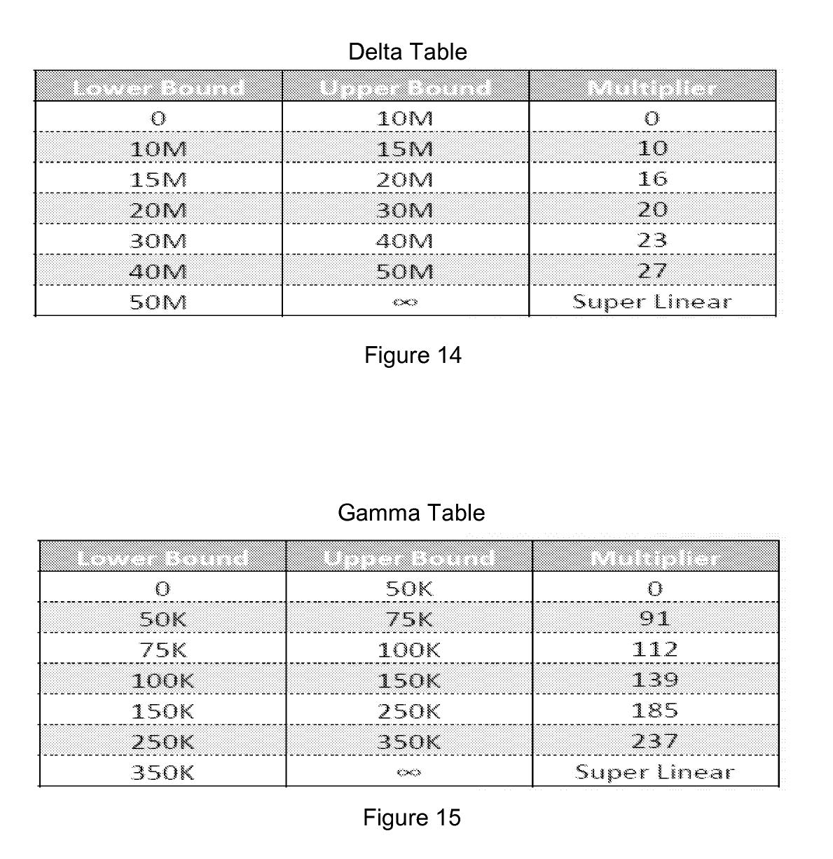

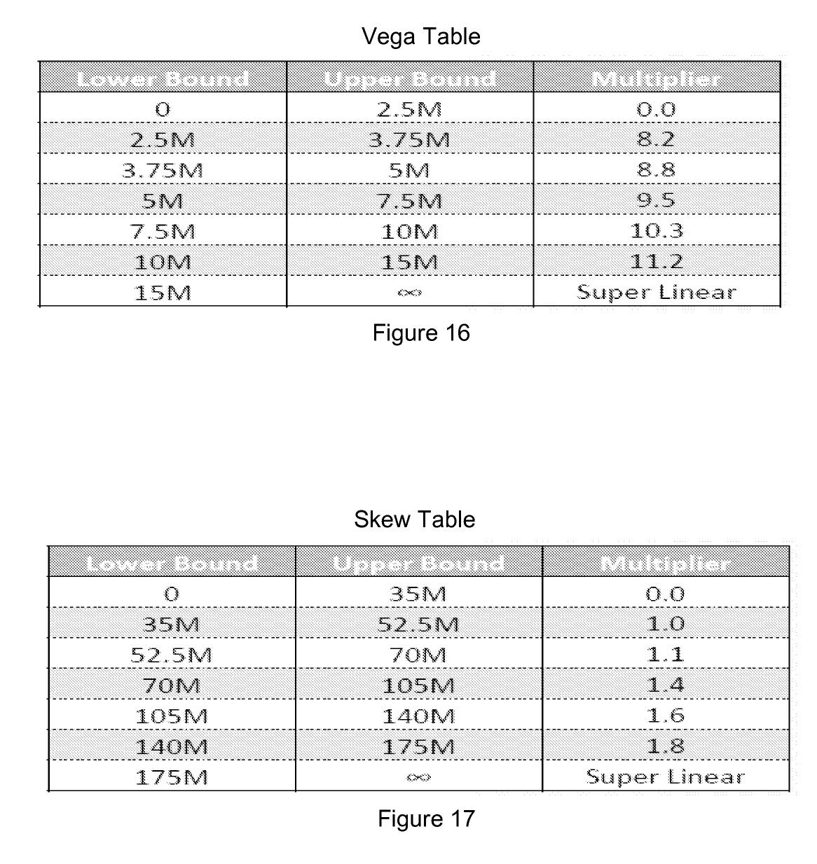

FIGS. 14-17 illustrate exemplary lookup tables. The lookup tables allow for the calculation of liquidation cost per each Greek type using the aggregated Greek calculation. The final liquidation cost, then, is the sum of the liquidation costs of all Greek types. FIG. 14 is delta lookup table. FIG. 15 is a gamma lookup table. FIG. 16 is a vega lookup table. And, FIG. 17 is a skew lookup table.

The present invention has been described in terms of preferred and exemplary embodiments thereof. Numerous other embodiments, modifications and variations within the scope and spirit of the invention will occur to persons of ordinary skill in the art from a review of this disclosure.

We claim:

1. A method of determining liquidation costs of a portfolio of financial instruments, the method comprising:
(a) determining at a processor a hedge cost for hedging a portion of the portfolio at a first time to create a partially hedged portfolio;
(b) determining at a processor a warehousing cost for warehousing an unhedged portion of the portfolio of financial instruments until a second time after the first time;
(c) determining at a processor a re-hedge cost for hedging the partially hedged portfolio at the second time; and
(d) determining the liquidation cost by combining the hedge cost, the warehousing cost and the re-hedge cost.

2. The method of claim 1, wherein (a) comprises:
(i) receiving survey data for liquidation costs at different risk profiles.

3. The method of claim 2, wherein survey data includes stressed market liquidation costs for risk profiles that are available during stressed market conditions.

4. The method of claim 3, wherein the survey data includes normal market liquidation costs for risk profiles that are not available during a stressed market condition.

5. The method of claim 4, wherein, (a) further includes:
(ii) creating at a processor cost functions from the survey data for the different risk profiles.

6. The method of claim 5, wherein (ii) comprises creating continuous parsimonious cost functions from the survey data for the different risk profiles.

7. The method of claim 6, wherein (a) comprises identifying optimal hedges using risk profiles that are available during a market crises by minimizing tail risks.

8. The method of claim 7, wherein (a) comprises identifying optimal hedges using risk profiles that are available during a market crises by minimizing tail risks using a conditional value at risk measure.

9. The method of claim 6, wherein (c) comprises identifying optimal hedges using risk profiles that are not available during a market crises by minimizing tail risks using a conditional value at risk measure.

10. The method of claim 1, wherein (b) comprises:
(i) determining an initial margin requirement at the first time using an initial margin period of risk;
(ii) determining a subsequent margin requirement at the first time using a subsequent margin period of risk greater than the initial margin period of risk; and
(iii) determining the warehousing cost by subtracting the initial margin requirement from the subsequent margin requirement.

11. The method of claim 10, wherein the initial margin period of risk is 5 days and the subsequent margin period of risk is 10 days.

12. The method of claim 1, wherein (d) comprises summing the hedge cost, the warehousing cost and the re-hedge cost.

13. The method of claim 1, further comprising:
(e) mapping the liquation costs determined in (d) to Greek coefficients.

14. The method of claim 13, wherein (e) comprises:
(i) determining weights for the Geek coefficients at a processor by regressing liquidation costs determined in (d) to the Greek coefficients; and
(ii) aggregating a weighted sum of the Greek coefficients and the weights to create an aggregated Greek.

15. A method comprising:
(a) determining liquidation costs of a portfolio of financial instruments
(b) determining at a processor weights for the Greek coefficients at a processor by regressing liquidation costs determined in (a) to the Greek coefficients; and
(c) aggregating at a processor a weighted sum of the Greek coefficients and the weights to create an aggregated Greek.

16. The method of claim 15, further comprising:
(d) creating tables for each Greek type that can be used to calculate liquidation costs using aggregated Greeks.

17. The method of claim 16, further comprising:
(e) determining a final liquidation costs by summing the liquidation cost for each Greek type.

18. A tangible non-transitory computer-readable medium containing computer executable instructions that when executed cause a computer device to perform the steps comprising:
(a) determining a hedge cost for hedging a portion of the portfolio at a first time to create a partially hedged portfolio;
(b) determining a warehousing cost for warehousing an unhedged portion of the portfolio of financial instruments until a second time after the first time;
(c) determining a re-hedge cost for hedging the partially hedged portfolio at the second time; and
(d) determining the liquidation cost by combining the hedge cost, the warehousing cost and the re-hedge cost.

19. The tangible non-transitory computer-readable medium of claim 18, wherein (a) comprises:
(i) receiving survey data for liquidation costs at different risk profiles.

20. The tangible non-transitory computer-readable medium of claim 18, wherein survey data includes stressed market liquidation costs for risk profiles that are available during stressed market conditions.
